(19) United States
(12) Patent Application Publication
(10) Pub. No.: US 2026/0298150 A1
(43) Pub. Date: Oct. 1, 2026

(54) COMPACT GEAR TRAIN FOR TURBOMACHINE REDUCER

(71) Applicant: SAFRAN TRANSMISSION SYSTEMS, Colombes (FR)

(72) Inventor: Guillaume Pierre MOULY, Moissy-Cramayel (FR)

(73) Assignee: SAFRAN TRANSMISSION SYSTEMS, Colombes (FR)

(21) Appl. No.: 18/874,235

(22) PCT Filed: Jun. 12, 2023
(86) PCT No.: PCT/FR2023/050844

§ 371 Date: Dec. 12, 2024

(30) Foreign Application Priority Data
Jun. 13, 2022 (FR) FR2205685

(51) Int. Cl. F02C 7/36; F02K 3/06; F16H 1/28

(52) U.S. Cl. CPC F02C 7/36; F02K 3/06; F16H 1/2809; F05D 2260/40311

(57) ABSTRACT

A gear train including a sun gear having a central axis, a ring gear disposed coaxially around the sun gear, a planet carrier, and a first and a second plurality of planet gears. Each planet gear is supported by the planet carrier and includes at least one first gearing meshing with the ring gear and two second gearings meshing with the sun gear and offset with respect to each other in the axial direction. Each of the first gearings of the first and second plurality of planet gears has a first median diameter, and each of the second gearings of the first and second plurality of planet gears has a second median diameter greater than the first median diameter. The second gearings of the second plurality of planet gears are disposed, in the axial direction, between the second gearings of the first plurality of planet gears.

### TECHNICAL FIELD

This disclosure relates to the field of gear trains, and in particular gear trains for a turbomachine mechanical reducer.

### PRIOR ART

Gears are mechanical assemblies in which movement can be transmitted, and where applicable converted, between two meshed solid elements. Their meshing can be ensured by contact, by friction, or even by magnetic field, and meshing by contact can normally be ensured using gearings, which can be for example straight-cut or inclined, or even helical. Gears can be used to convert a rotary movement into a linear movement or vice versa, for example with a rack and pinion gearing, but especially to convert a first rotary movement into a second rotary movement which is different from the first rotary movement in speed and/or direction of rotation. It is thus in particular possible to use at least one gear, or several gears together forming a gear train, in a mechanical reducer to convert the faster rotation of an input shaft into a slower rotation of an output shaft.

A particular field of use of mechanical reducers is that of turbomachines. This is because turbomachines, and in particular gas turbine engines, can have comparatively high rotation speeds which it may be advisable to reduce for practical use. Thus, in turbofans, the direct driving of the fan by a turbine can limit the maximum diameter of the fan, and therefore the bypass ratio of the turbojet engine, since the rotation speed of the fan with the turbine can be such that transonic speeds are quickly reached at the end of the fan airfoil, even with moderate diameters. Provision has therefore already been made for inserting a mechanical reducer between a turbine and a fan so that this latter is rotationally driven at a substantially lower speed than that of the turbine driving it. For similar reasons, provision has also been made for mechanical reducers for other turbomachines. Thus, in the field of aeronautical propulsion, it is common to incorporate a mechanical reducer between a turbine and a pusher propeller in a turboprop engine, or between a turbine and a lift rotor in a turboshaft engine. The incorporation of a mechanical reducer into a turbomachine is also common in other fields, such as for example terrestrial or naval propulsion or electrical power generation.

In several of these fields, and particularly in the field of aeronautical propulsion, it can be advantageous to have a mechanical reducer which is particularly compact, but offers a high reduction ratio. One class of gear trains offering comparatively high reduction ratios with a relatively small bulk are gear trains with a sun gear, a ring gear disposed coaxially around the sun gear, and a planet carrier with planet gears meshing with the sun gear and the ring gear, as disclosed for example in the French patent application with publication number FR 2 928 976 A1. To offer particularly high reduction ratios, each planet gear can have at least two gearings of different diameters, one meshing with the sun gear and the other with the ring gear. A mechanical reducer for a turbomachine including a gear train with such a configuration has been disclosed for example in the European patent application publications EP 3 726 031 A1 and EP 3 361 122 A1 and in the French patent application with publication number FR 3 008 463 A1.

In such a gear train, it may be advantageous to increase the number of planet gears in order to distribute between them the torque transmitted by the gear train. However, when the radial bulk of the gear train is restricted, interference between the planet gears limits their number. To avoid this, provision has been made, particularly in the European patent application publication EP 1 113 193 A2, for having a first plurality of planet gears and a second plurality of planet gears, in which the gearings with largest diameter are axially offset with respect to those of the first plurality of planet gears. However, in this gear train, this entails different amounts of overhang for the gearings of the two pluralities of planet gears, which can cause bending and twisting torques in the planet gears, and make the balancing of the gear train more difficult.

### SUMMARY OF THE INVENTION

A first aspect of this disclosure relates to a gear train for a mechanical reducer for a turbomachine. This gear train includes a sun gear having a central axis, a ring gear disposed coaxially around the sun gear, a planet carrier, and a first and a second plurality of planet gears in which each planet gear is supported by the planet carrier. Each planet gear can include at least one first gearing and two second gearings offset with respect to one another in an axial direction, parallel to said central axis. Each of the first gearings can mesh with the ring gear and have a first median diameter, and each of the second gearings can mesh with the sun gear and have a second median diameter greater than the first median diameter. To allow the interlacing of the second gearings, the second gearings of the second plurality of planet gears can be disposed, in said axial direction, between the second gearings of the first plurality of planet gears.

Thus, owing to the interlacing of the second gearings, which are those of larger diameter, it becomes possible to combine a high reduction ratio and a large number of planet gears and therefore a high power transmission capacity of the gear train. However, this arrangement also makes it possible to minimize overhang and twisting and bending torques in each planet gear.

To simplify the balancing of the gear train, the two second gearings of each planet gear can in particular be disposed symmetrically with respect to a transverse plane perpendicular to the central axis.

At least one of said planet gears can include a single first gearing, which is centered on the transverse plane. It may however also be envisioned for at least one of said planet gears to include two first gearings, which can then be disposed symmetrically with respect to the transverse plane.

Said first gearings can be straight-cut. In order to allow their correct meshing with the ring gear, this gear can have at least one corresponding straight-cut gearing.

Alternatively, however, said first gearings can be helical. In this case, to balance the axial forces on the planet gears, each planet gear can include two of said first gearings, inclined in opposite directions. Moreover, in order to allow their correct meshing with the ring gear, this can also have corresponding helical gearings. However, a single first herringbone gearing may also be envisioned on each planet gear, along with a corresponding gearing on the ring gear.

The second gearings of the planet gears of the first plurality of planet gears and/or the second gearings of the planet gears of the second plurality of planet gears can also be straight-cut. In order to allow their correct meshing with the sun gear, this gear can also have corresponding straight-cut gearings.

Alternatively, however, the second gearings of the planet gears of the first plurality of planet gears and/or the second gearings of the planet gears of the second plurality of planet gears can also be straight-cut can also be helical. In this case, to balance the axial forces on the planet gears, the second gearings of each planet gear of the first and/or second pluralities of planet gears can be inclined in opposite directions. Moreover, in order to allow their correct meshing with the sun gear, this can also have corresponding helical gearings.

Each planet gear of the first and second pluralities of planet gears can be mounted to rotate freely about a corresponding axis using a respective bearing, which can in particular be a ball bearing, although other types of bearing, in particular hydrostatic bearings, may also be envisioned.

Each planet gear of the first and second pluralities of planet gears includes at least two parts rotationally attached to one another with complementary non-axisymmetric profiles. These non-axisymmetric profiles can in particular be polygonal profiles with rounded angles, such as for example three-lobed profiles such as P3G profiles as per the OIN 32711 standard, particularly suitable for rotationally securing parts not subject to axial slip, although other non-axisymmetric profiles, such as for example a four-lobed P4C profile as per the OIN 32712 standard or a splined profile, may also be envisioned. Each planet gear can also include retaining elements, such as for example nuts, to axially retain the at least two parts together.

A second aspect of this disclosure relates to a mechanical reducer comprising the gear train according to the first aspect, at least one input shaft mechanically rotationally coupled to one from among the sun gear, the ring gear, and the planet carrier, and an output shaft mechanically rotationally coupled to another from among the sun gear, the ring gear, and the planet carrier.

A third aspect of this disclosure relates to a turbomachine including the mechanical reducer according to the second aspect, at least one turbine and a rotary device, as well as the use of the mechanical reducer according to the second aspect in such a turbomachine. In this turbomachine, the at least one turbine can be mechanically rotationally coupled to the at least one input shaft of the reducer and the rotary device can be mechanically rotationally coupled to the output shaft. In particular, the rotary device can be a fan, in order to thus form a turbofan with a reducer fan. However, it may also be envisioned for the rotary device to be a pusher propeller or a lift fan, or even a drive wheel, a hydraulic transmission or an electrical power generator.

### BRIEF DESCRIPTION OF THE DRAWINGS

The subject of this summary and its advantages will be better understood on reading the detailed description given hereinafter of embodiments given by way of non-limiting example. This description refers to the appended pages of figures, on which:

FIG. 1 is a schematic representation of a turbomachine with a mechanical reducer.

FIG. 2 schematically represents a mechanical reducer according to a first embodiment.

FIG. 3 is a detail view of a planet carrier and of a lubrication system of the mechanical reducer of FIG. 2.

FIG. 4 schematically illustrates a non-axisymmetric profile of P3G type, of a type which can be used to rotationally secure to one another at least two separate parts of each planet gear of the mechanical reducer of FIG. 4.

FIG. 5 schematically illustrates the orientation of the gearings of the planet gears of the mechanical reducer of FIG. 2.

FIG. 6 schematically illustrates the orientation of the gearings of the planet gears of a mechanical reducer according to a second embodiment.

FIG. 7 illustrates the arrangement of the bearings of the planet gears of the mechanical reducer of FIG. 6.

FIG. 8 schematically illustrates a mechanical reducer according to a third embodiment.

FIG. 9 schematically illustrates the orientation of the gearings of the planet gears of the mechanical reducer of FIG. 8.

FIG. 10 schematically illustrates a mechanical reducer according to a fourth embodiment.

FIG. 11 schematically illustrates a turbomachine with a mechanical reducer according to a fifth embodiment.

FIG. 12 schematically illustrates the mechanical reducer according to the fifth embodiment.

### DESCRIPTION OF THE EMBODIMENTS

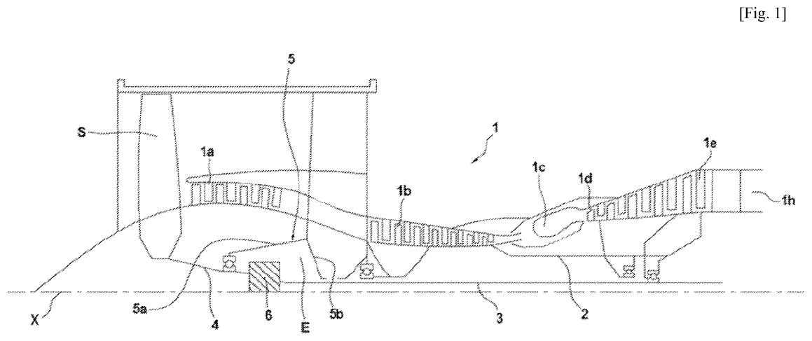

As illustrated on FIG. 1, a turbomachine 1 can take the form of a turbofan including, conventionally, a fan S, a low-pressure compressor 1a, a high-pressure compressor 1b, a combustion chamber 1c, which can be annular, a high-pressure turbine 1d, a low-pressure turbine 1e and an exhaust nozzle 1h. The high-pressure compressor 1b and the high-pressure turbine 1d may be mechanically rotationally connected by a high-pressure shaft 2 and thus form with it a high-pressure (HP) spool. The low-pressure compressor 1a and the low-pressure turbine 1e may be mechanically rotationally connected by a low-pressure shaft 3 and thus form with it a low-pressure (LP) spool.

To be driven, the fan S can be rotationally secured to a fan shaft 4 mechanically rotationally connected to the low-pressure shaft 3 through a mechanical reducer 6. This mechanical reducer 6 can be, for example, of planetary, epicyclic or differential type. Owing to this mechanical reducer 6, it is therefore possible to drive the fan S at a lower rotation speed than that of the low-pressure shaft 3, the low-pressure compressor 1a and the low-pressure turbine 1e, thus allowing the fan S to have a larger diameter and thus offer a higher bypass ratio.

As illustrated on FIG. 1, the reducer 6 can be positioned in a forward part of the turbomachine 1, in the upstream direction with respect to the low-pressure and high-pressure spools. Alternative arrangements, disposing the reducer 6 in an aft part, or even an intermediate part of the turbomachine, may however be envisioned. A fixed structure forming an engine casing or stator 5, and able to comprise, as illustrated, an upstream part 5a and a downstream part 5b, can be arranged in such a way as to form a chamber E surrounding the reducer 6. This chamber E can be, as illustrated, closed upstream by seals level with a bearing allowing the traversal of the fan shaft 4, and downstream by seals level with the traversal of the low-pressure shaft 3.

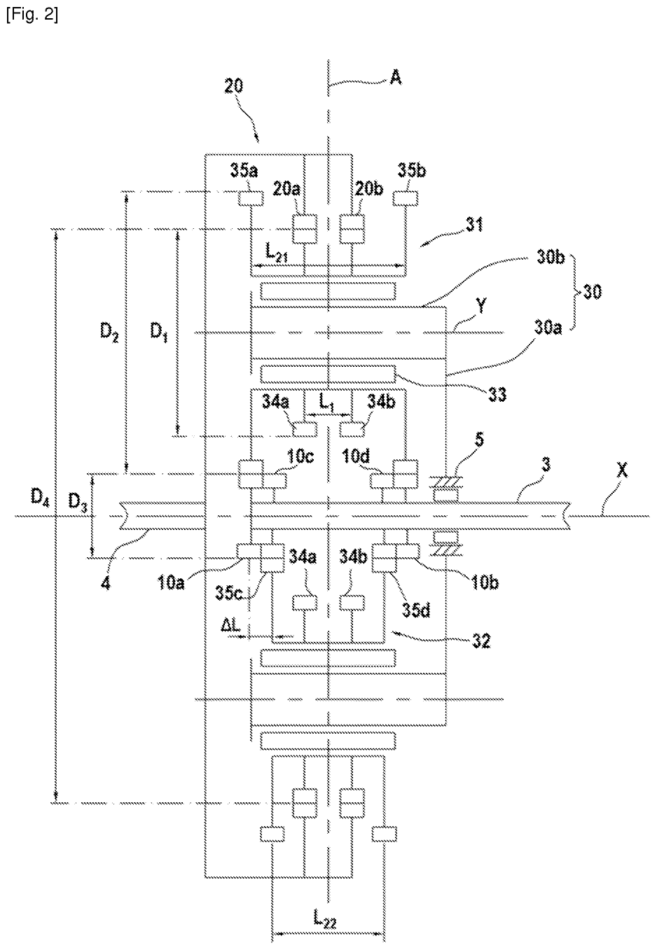

According to a first embodiment, illustrated on FIG. 2, the mechanical reducer 6 can be a planetary reducer with a gear train comprising a sun gear 10 rotationally secured to the low-pressure shaft 3, a ring gear 20 disposed coaxially around the sun gear 10, with the same central axis X as this gear, and rotationally secured to the fan shaft 4, and a planet carrier 30 secured to the casing 5 and therefore fixed. The central axis X common to the sun gear 10 and to the ring gear 20 can be aligned with an axis of rotation of the high-pressure 2 and low-pressure 3 shafts. The rotational couplings between the sun gear 10 and the low-pressure shaft 3 and/or between the ring gear 20 and the fan shaft 4 can therefore be made, for example, by way of splines.

The gear train of the mechanical reducer 6 can also comprise two planet gear assemblies 31, 32 carried by the planet carrier 30 and distributed around the central axis X, for example at substantially identical angular intervals. Each planet gear 31, 32 can be mounted to rotate freely about a corresponding axis Y, which can in particular be substantially parallel to the central axis X, using a respective bearing 33. Each planet gear 31, 32 can include two first gearings 34a,34b, of a first median diameter D₁, meshing with two corresponding gearings 20a, 20b in the ring gear 20. The first gearings 34a, 34b of each planet gear 31,32 can be offset with respect to one another in the direction of the axis Y, with an axial offset L₁. In particular, in order to ensure a good balancing of the forces on the planet gears 31, 32, said first gearings 34a, 34b can have substantially the same width and be symmetrically disposed with respect to a transverse plane of symmetry A.

The planet gears 31 of a first set of planet gears 31 and the planet gears 32 of a second set of planet gears 32 can be disposed alternately around the sun gear 10. Each planet gear 31 of the first set of planet gears 31 can include, apart from the two first gearings 34a, 34b, two second gearings 35a, 35b, of a second median diameter D₂, meshing with corresponding gearings 10a, 10b of the sun gear 10. The gearings 10a, 10b of the sun gear 10 may have a third median diameter D3 less than the second median diameter D₂, while the gearings 20a, 20b of the ring gear 20 may have a fourth median diameter D₄ greater than the first median diameter D₁, in order to obtain a reduction ratio between the rotation speeds of the sun gear 10 and of the ring gear 20. The second median diameter D₂ may be greater than the first median diameter D₁, in such a way as to obtain a higher reduction ratio between the rotation speeds of the sun gear 10 and of the ring gear 20. The second gearings 35a, 35b of each planet gear 31 of the first set of planet gears 31 can also be offset with respect to one another in the direction of the axis Y. In particular, in order to ensure a good balancing of the forces on the planet gears 31, said second gearings 35a, 35b can also have substantially the same width and be disposed symmetrically with respect to the transverse plane of symmetry A with, between them, an axial offset L₂₁ greater than the axial offset Li between the first gearings 34a, 34b, in such a way as to be axially disposed outside these first gearings 34a, 34b.

In this first embodiment, each planet gear 32 of the second set of planet gears 36 can also include, apart from the two first gearings 34a, 34b, two second gearings 35c, 35d with the same second median diameter D₂. Like the second gearings 35a,35b of the planet gears 31 of the first set, the second gearings 35c, 35d of the planet gears 32 of the second set can also mesh with corresponding gearings 10c, 10d of the sun gear 10. The second gearings 35c, 35d of each planet gear 32 of the second set of planet gears 32 can also be offset with respect to one another in the direction of the axis Y. In particular, in order to ensure a good balancing of the forces on the planet gears 31, said second gearings 35c, 35d of each planet gear 32 of the second set of planet gears 32 can also have substantially the same width and be disposed symmetrically with respect to the transverse plane of symmetry A. The axial offset L₂₂ between the two second gearings 35c, 35d of each planet gear 32 of the second set of planet gears 32 can also be greater than the axial offset L₁ between the first gearings 34a, 34b, in such a way that the first gearings 34a, 34b are also disposed between the second gearings 35c, 35d of the second plurality of planet gears 32, but however be less than the axial offset L2 between the second gearings 35a, 35b of each planet gear 31 of the first set of planet gears 31, in such a way that the second gearings 35c, 35d of the planet gears 32 of the second set of planet gears 32 are disposed in the axial direction, between the second gearings 35a, 35b of the planet gears 31 of the first set of planet gears 31. One may thus obtain, between the second gearings 35a, 35b of the planet gears 31 of the first set and the second gearings 35c, 35d of the planet gears 32 of the second set, an axial offset ΔL, equal to half the difference between the axial offsets L21 and L22, which makes it possible bring the axes Y of the planet gears 31, 32 of the two sets closer together, with no collision between the second gearings 35a-35d of adjacent planet gears 31, 32, and therefore to distribute the mechanical load between a larger number of planet gears 31, 32 with a small radial bulk.

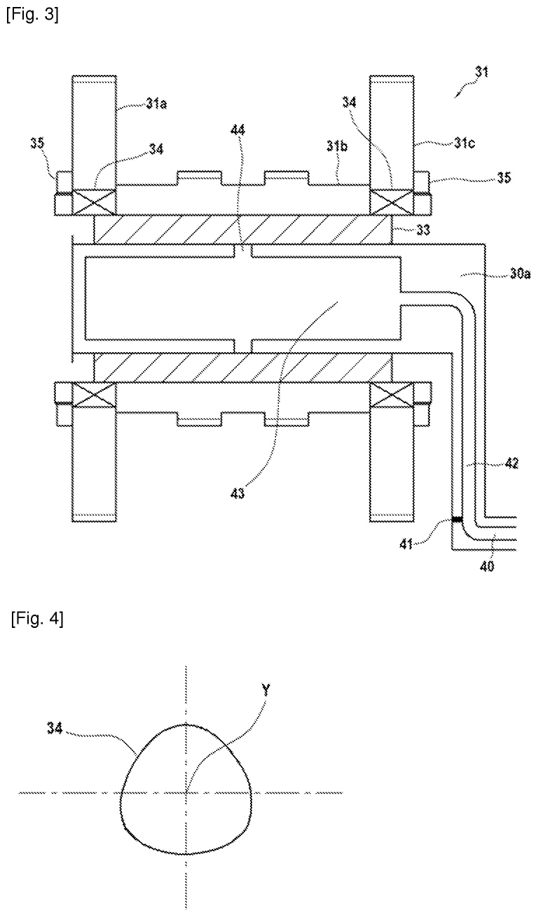

As illustrated in detail on FIG. 3, each bearing 33, which can for example be a ball bearing or hydrostatic bearing, can be mounted on a shaft 30b of the planet carrier 30, in such a way that each planet gear 31 or 32 is internally supported around one of the shafts 30b by the corresponding bearing 33. In this case, all the shafts 30b of the planet carrier 30 can be positioned with respect to one another using one or more structural frames 30a of the planet carrier 30. For reasons of operation, installation, manufacturing, repair control and/or replacement, the shafts 30b and the frame 30a of the planet gear 30 can be separable into several parts. To lubricate the reducer 6, this may comprise a distributor 40 of lubricant with injectors 41 for lubricating the gears and a number of arms 42 opening, through buffer cavities 43 in the shafts 30b of the planet gear, onto supply inlets 44 of the bearings 33 to lubricate these latters. A lubricant can therefore follow the path illustrated by the arrows of FIG. 3 to lubricate the bearings and gears.

Furthermore, in order to simplify the assembly of the gear train, each planet gear 31, 32 can include at least two, preferably three parts 31a,31b,31c rotationally attached to one another, for example with fitted complementary non-axisymmetric profiles 34, which can in particular be P3G three-lobed profiles as per the OIN 32711 standard, such as that illustrated on FIG. 4. The three parts 31a,31b,31c can be axially retained with nuts 35.

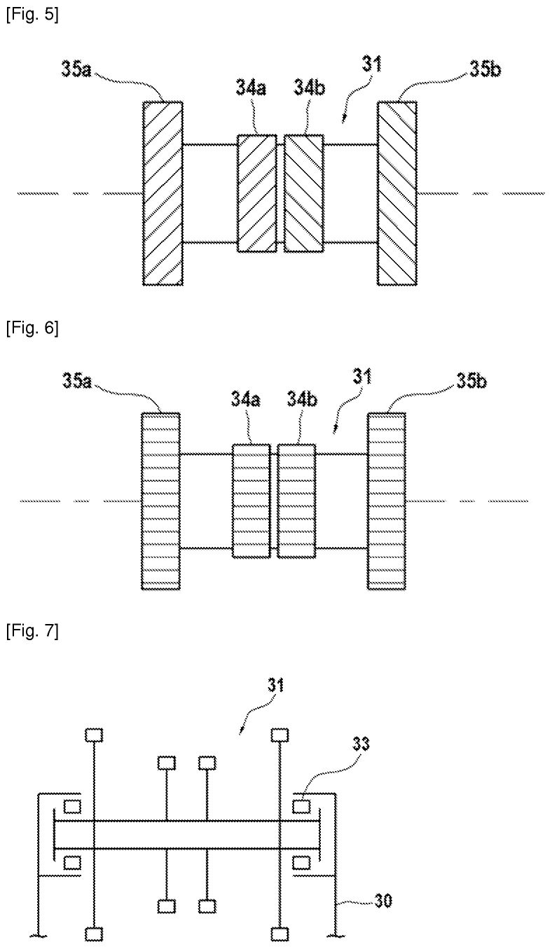

In this first embodiment, the gearings can be helical gearings. As illustrated on FIG. 5, the two first gearings 34a, 34b of each planet gear 31, 32 can be inclined in opposite directions, in particular symmetrically, to obtain a balancing of axial forces in each planet gear 31, 32. Consequently, to obtain a correct meshing, the corresponding gearings 20a, 20b in the ring gear 20 can have the same inclinations. Similarly, the two second gearings 35a-35d of each planet gear 31, 32 can also be inclined in opposite directions, in particular symmetrically, to obtain a balancing of axial forces in each planet gear 31, 32. Consequently, to obtain a correct meshing, the corresponding gearings 10a-10d on the sun gear 10 may also have the same inclinations.

It may however also be envisioned for at least some of all these gearings to be straight-cut. Thus, in a second embodiment, illustrated on FIG. 6, the set of gearings 34a,34b and 35a-35d of each planet gear 31,32 can be straight-cut gearings, just like the corresponding gearings on the sun gear 10 and on the ring gear 20. In this case, the four corresponding gearings on the sun gear 10 could be replaced by a single through gearing 10a of sufficient width to mesh with the second gearings 35a-35d of each planet gear 31, 32. It can also be envisioned for the planet gears 31 and 32 to be supported at their axial ends by outer bearings 33, as in the first embodiment. In this second embodiment, the other elements of the reducer 6 can be identical or at least equivalent to those of the first embodiment and also arranged in the same way or in a similar way. They consequently take the same reference signs on FIGS. 6 and 7 as on the preceding figures.

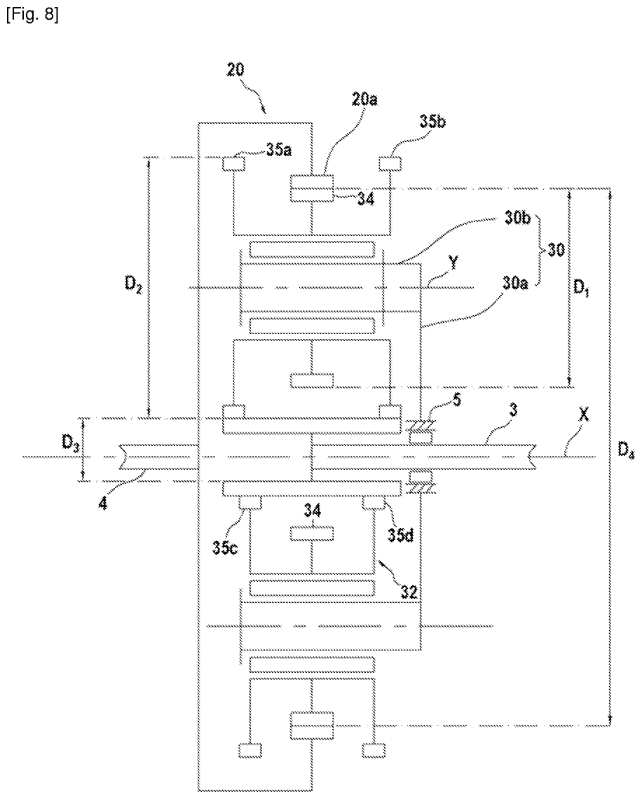

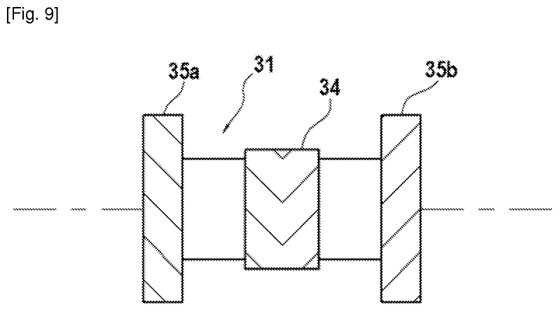

As the two first gearings of each planet gear are adjacent, it may also be envisioned, in a third embodiment, illustrated on FIG. 8, to replace them with a single first gearing 34, which can be embodied as a single part, centered on the transverse plane of symmetry A. In this case, this first gearing 34 of each planet gear 32 can be herringbone gearing, as illustrated on FIG. 8. Alternatively, however, it could be a straight-cut gearing, as in the second embodiment. As illustrated on FIG. 8, the first gearings 34 of the planet gears 31 of this third embodiment could mesh on a single corresponding gearing 20a on the ring gear 20. In this third embodiment, the other elements of the reducer 6 may also be identical or at least equivalent to those of the preceding embodiments and also arranged in the same way or in a similar way. They consequently take the same reference signs on FIGS. 8 and 9 as on the preceding figures.

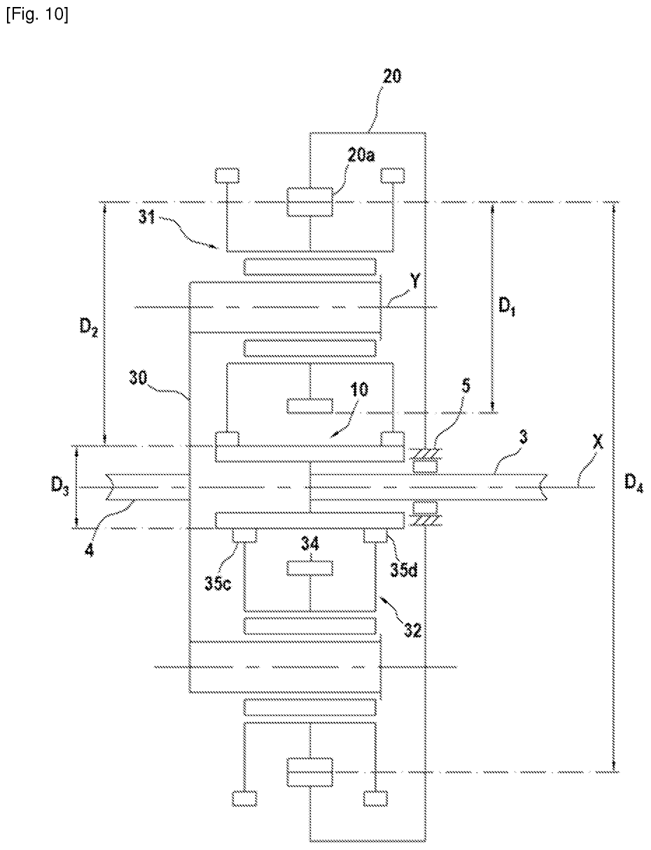

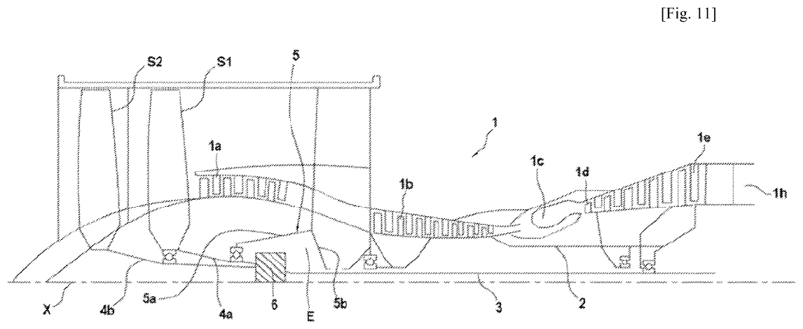

Although, in these first three embodiments, the gear train is a planetary gear train, in which the planet carrier 30 is fixed, it may also be envisioned for the mechanical reducer 6 to instead comprise an epicyclic gear train, in which the ring gear 20 is secured to the casing 5 and therefore fixed, and the planet carrier 30 is rotationally secured to the fan shaft 4, as in the fourth embodiment illustrated on FIG. 9. In this fourth embodiment, the other elements of the reducer 6 can also be identical or at least equivalent to those of the preceding embodiments and also arranged in the same way or in a similar way. They consequently take the same reference signs on FIG. 10 as on the preceding figures.

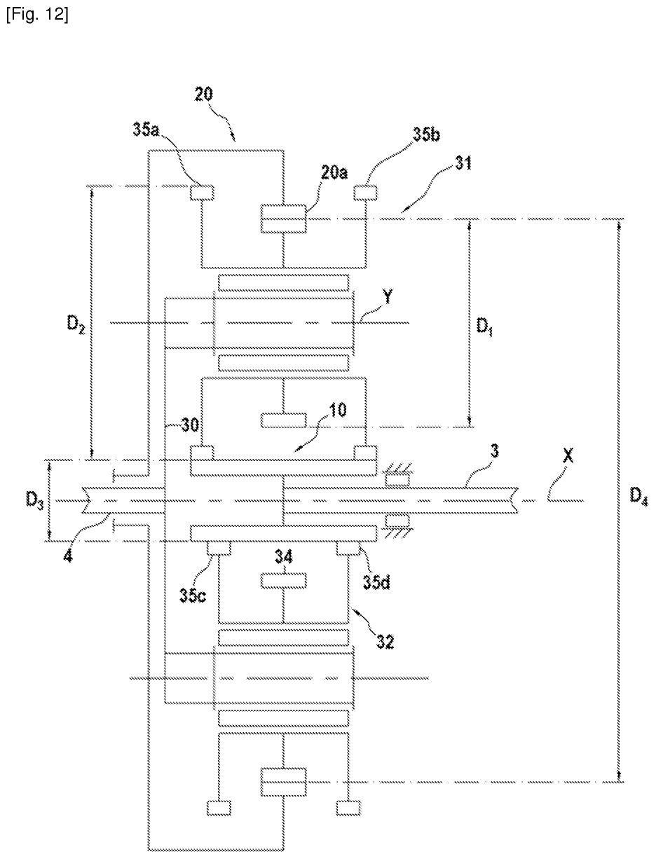

Moreover, it may also be envisioned, in particular for a turbomachine 1 with a fan S with counter-rotating blades S1, S2, for the gear train to be a differential gear train. As illustrated on FIGS. 11 and 12, the sun gear 10 could then be rotationally secured to the low-pressure shaft 3, the ring gear 20 of a first fan shaft 4a, and the planet carrier 30 of a second counter-rotating fan shaft 4b. Apart from this, in this fifth embodiment, the other elements of the reducer 6 can also be identical or at least equivalent to those of the preceding embodiments and also arranged in the same way or in a similar way. They consequently take the same reference signs on FIGS. 11 and 12 as on the preceding figures.

Although this invention has been described with reference to specific embodiments, it is obvious that modifications and changes to these examples can be made without departing from the general scope of the invention as defined by the claims. In particular, individual features of the different embodiments illustrated/mentioned, such as for example the straight-cut gearings and/or the outer bearings of the planet gears of the second embodiment and the general architectures of the following embodiments, may be combined into additional embodiments. Consequently, the description and drawings must be considered in an illustrative sense rather than a restrictive one.

1. A gear train for a mechanical reducer for a turbomachine, said gear train including:
a sun gear having a central axis,
a ring gear disposed coaxially around the sun gear,
a planet carrier, and
a first and a second plurality of planet gears, in which each planet gear is supported by the planet carrier and includes at least one first gearing and two second gearings offset with respect to one another in an axial direction, parallel to said central axis,
each of the first gearings, meshing with the ring gear and having a first median diameter, and
each of the second gearings meshing with the sun gear and having a second median diameter greater than the first median diameter, wherein the second gearings of the second plurality of planet gears are disposed, in said axial direction, between the second gearings of the first plurality of planet gears.

2. The gear train as claimed in claim 1, wherein the two second gearings of each planet gear are disposed symmetrically with respect to a transverse plane perpendicular to the central axis.

3. The gear train as claimed in claim 1, wherein at least one of said planet gears includes a single first gearing centered on the transverse plane.

4. The gear train as claimed in claim 1, wherein at least one of said planet gears includes two first gearings, disposed symmetrically with respect to the transverse plane.

5. The gear train as claimed in claim 1, wherein the first gearings of the planet gears of the first and second pluralities of planet gears, the second gearings of the planet gears of the first plurality of planet gears, and/or the second gearings of the planet gears of the second plurality of planet gears are straight-cut.

6. The gear train as claimed in claim 1, wherein said first gearings, the second gearings of the planet gears of the first plurality of planet gears, and/or the second gearings of the planet gears of the second plurality of planet gears are helical.

7. The gear train as claimed in claim 6, wherein two of said first gearings of each planet gear, the second gearings of each planet gear of the first plurality of planet gears, and/or the second gearings of each planet gear of the second plurality of planet gears are inclined in opposite directions.

8. The gear train as claimed in claim 1, wherein each planet gear of the first and second pluralities of planet gears is mounted to rotate freely about a corresponding axis using a respective bearing.

9. The gear train as claimed in claim 1, wherein each planet gear of the first and second pluralities of planet gears includes at least two parts rotationally attached to one another with complementary non-axisymmetric profiles.

10. A mechanical reducer for a turbomachine comprising the gear train as claimed in claim 1, at least one input shaft mechanically rotationally coupled to one from among the sun gear, ring gear, and the planet carrier, and an output shaft mechanically rotationally coupled to another from among the sun gear, the ring gear, and the planet carrier.

11. A turbomachine including the mechanical reducer for a turbomachine as claimed in claim 10, at least one turbine and a rotary device, wherein the at least one turbine is mechanically rotationally coupled to the at least one input shaft of the mechanical reducer and the rotary device is mechanically rotationally coupled to the output shaft.

12. The turbomachine as claimed in claim 11, wherein the rotary device is a fan.
